(19) United States
(12) Patent Application Publication
(10) Pub. No.: US 2011/0087604 A1
(43) Pub. Date: Apr. 14, 2011

(54) MICRO-BLOGGING FOR ENTERPRISE RESOURCES PLANNING (ERP)

(75) Inventors: Chang Uk Chung, Mountain House, CA (US); Jason Alonzo, Fair Oaks, CA (US); Umesh Apte, San Ramon, CA (US); John Leong Yee, San Mateo, CA (US)

(73) Assignee: Oracle International Corporation, Redwood Shores, CA (US)

(21) Appl. No.: 12/973,393

(22) Filed: Dec. 20, 2010

Related U.S. Application Data
(63) Continuation-in-part of application No. 12/576,988, filed on Oct. 9, 2009.

(51) Int. Cl. G06Q 10/00

(52) U.S. Cl. 705/301

(57) ABSTRACT

The present invention is directed to methods and systems for implementing enterprise application-based micro-blogging. The method includes receiving a micro-blog registration for an enterprise application for at least one user, verifying the role and access level of the user, and based on the registration, the role, and access level, receiving setting information from the at least one user to configure following of at least one object associated with the enterprise application. The method further includes recording an event to the micro-blog for the at least one object, determining that the at least one user is configured to follow the at least one object, and in response to following the at least one object, receiving a notification that at least one update to the at least one object has occurred. Further, the method includes displaying, in real-time, within the enterprise application-based micro-blog the at least one update to the at least one object to the at least one user.

### PRIORITY CLAIM

This application is a continuation-in-part of U.S. patent application Ser. No. 12/576,988, entitled METHODS AND SYSTEMS FOR PROVIDING A COMPREHENSIVE VIEW OF IT ASSETS AS SELF SERVICE INQUIRY/UPDATE TRANSACTIONS, filed on Oct. 9, 2009, which is incorporated by reference in its entirety for any and all purposes.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### BACKGROUND OF THE INVENTION

In the face of an emerging and changing technological environment, social networking has impacted the world of enterprise application users. This impact has caused changes in human behavior with personal usage of software and applications and as result it has impacted business application usage, and users are adapting to the technology in both their personal lives and in their professional environments. As such, use of these social networking tools and applications can be easily and seamlessly adapted and extended to end users of an ERP financial (and other) applications.

Previously, end-users could retrieve ERP information directly from the ERP applications; however, the delivery and recordation of such the information is inadequate. In one example, a user may need to take the initiative to determine what information is stored in an ERP system, which can be time consuming and reduce productivity.

Furthermore, currently users attempt to distribute asset information through an asset management system. This software allows for notification of some asset information and status changes to predefined users. In one case a predefined user can receive an email about unauthorized software, but only certain predefined users can receive emails. There is a way to collect asset comments, but no way to easily distribute that information to interested parties. The current model allows ERP users to seek out historical asset changes, but does little to allow for a proactive model, whereby users select the assets and information that they want to receive, instead of having to navigate through the ERP to identify changes. Hence, improved rating and ranking methods and systems are needed in the art.

### SUMMARY OF THE INVENTION

In one embodiment, a method for implementing enterprise application-based micro-blogging is described. The method includes receiving a micro-blog registration for an enterprise application for at least one user, verifying the role and access level of the user, and based on the registration, the role, and access level, receiving setting information from the at least one user to configure following of at least one object associated with the enterprise application. The method further includes recording an event to the micro-blog for the at least one object, determining that the at least one user is configured to follow the at least one object, and in response to following the at least one object, receiving a notification that at least one update to the at least one object has occurred. Further, the method includes displaying, in real-time, within the enterprise application-based micro-blog the at least one update to the at least one object to the at least one user.

In another embodiment, a computer-readable medium for implementing enterprise application-based micro-blogging is described. The computer-readable medium includes instructions for receiving a micro-blog registration for an enterprise application for at least one user, verifying the role and access level of the user, and based on the registration, the role, and access level, receiving setting information from the at least one user to configure following of at least one object associated with the enterprise application. The computer-readable medium further includes instructions for recording an event to the micro-blog for the at least one object, determining that the at least one user is configured to follow the at least one object, and in response to following the at least one object, receiving a notification that at least one update to the at least one object has occurred. Further, the computer-readable medium includes instructions for displaying, in real-time, within the enterprise application-based micro-blog the at least one update to the at least one object to the at least one user.

In yet another embodiment, a system for implementing enterprise application-based micro-blogging is described. The system includes an object management system. The object management system is configured to receive a micro-blog registration for an enterprise application for at least one user, verify the role and access level of the user, and based on the registration, the role, and access level, receive setting information from the at least one user to configure following of at least one object associated with the enterprise application. The object management system is further configured to record an event to the micro-blog for the at least one object, determine that the at least one user is configured to follow the at least one object, and in response to following the at least one object, receive a notification that at least one update to the at least one object has occurred. Further, the object management system is configured to display, in real-time, within the enterprise application-based micro-blog the at least one update to the at least one object to the at least one user.

### BRIEF DESCRIPTION OF THE DRAWINGS

FIG. 1 is a flow diagram for implementing enterprise-based micro-blogging, in accordance with aspects of the present invention.

FIG. 2A is a flow diagram for implementing a method of micro-blogging for custodian hardware management, in accordance with embodiments of the present invention.

FIG. 2B is a flow diagram for implementing a method of managing hardware (and other asset) depreciation using micro-blogging, in accordance with embodiments of the present invention.

FIG. 2C is a flow diagram for implementing a method of managing software installation and usage using micro-blogging, in accordance with embodiments of the present invention.

FIG. 2D is a flow diagram for implementing a method of implementing micro-blogging for IT managers, in accordance with embodiments of the present invention.

FIG. 2E is a flow diagram for implementing a method of purchase order management using micro-blogging, in accordance with embodiments of the present invention.

FIG. 3 is a block diagram for implementing a system for implementing enterprise-based micro-blogging, in accordance with aspects of the present invention.

FIGS. 4A and 4B are graphical user interfaces (UIs) of ERP micro-blogging, in accordance with embodiments of the present invention.

FIG. 5 is a simplified block diagram illustrating physical components of a system environment 500 that may be used in accordance with an embodiment of the present invention.

FIG. 6 is a simplified block diagram illustrating the physical components of a computer system 600 that may be used in accordance with an embodiment of the present invention.

### DETAILED DESCRIPTION OF THE INVENTION

The present invention is directed to micro blogging in ERP and other enterprise application systems. As end users interact with different groups of people, for personal or business purposes, and as the end users adapt to the increasingly prevalent micro blogging technologies, the interaction could occur via a number of devices. For example, personal computers and mobile devices which allow exchanging information in real time, such real time event information can be broadcasted and propagated immediately. Additionally, as the user becomes more proficient in interacting with systems and other users through event driven micro blogging, aspects of the present invention will provide the business systems a similar manner of communication.

Such interaction may occur as information is changed, such as, an update (i.e., a change in assets status, etc.) of an event or in response to messages posted by one user. For example, this could be blogs posted by a user or comments entered in an ERP system (e.g., Asset Comments, etc.). Then, this information can be instantly broadcasted to the group that belong or interested group. With micro-blogging the information will be pushed out without any initiative or interaction need on part of the user, except possible for setting up which information (e.g., which IT Assets) the user desires to receive updates on. For example, the message can be considered anything that allows communicating between followers and following parties. This can contain schedule activity, or anything in the form of short texts. Such communication may be in the form of a micro-blog posting, instant message, asset comments entered in an asset management system, etc.

Further aspects of the present invention utilizes micro-blogging, in the context of enterprise applications and IT asset management, to provide new concepts in tracking asset information, consolidating such information, and quickly and effectively distributing the information. End-users, across many roles, can receive information from different sources and have the information displayed in a centralized place.

Merely for the purpose of explaining an illustrating aspects of the present invention, aspects of the present invention will be illustrated with respect to IT asset information and management. However, it will be understood to one skilled in the art that the present invention can be applied to any enterprise application environment; furthermore, enterprise based micro-blogging would allow users to more effectively and efficiently to leverage ERP system data and information.

For example, the present invention can receive and distribute information through multiple sources. Some such examples include SMS, Email, Instant Message, a UI available as a web page, etc. The UI may allows users to view and update status, etc. The messages can be thought of as anything that is a pertinent communication between “followers” of the IT assets. Some examples may include changes in operational status, scheduled activities, changes of users, software installation, etc.

Furthermore, since an ERP system is already designed to perform certain functionalities that involve the usage of statuses as the data travels across the transaction flow and modules, enterprise based micro-blogging is strategically placed to leverage such data. Therefore, one advantage of the enterprise based micro-blogging system is to increase efficiently by not going through the time to create reports, and additionally, it could create a better dynamism between the end user and the application to increase productivity. Accordingly, micro-blog home pages are then used in lieu of reporting because all of the events of that object are already stored in the micro-blog. Furthermore, the enterprise based micro-blog would provide more “real-time” information rather than waiting for the ERP reports to be generated.

Further, end users can select to “follow” IT assets and receive information, alerts, or messages about the followed IT asset (in lieu of the ERP reports). In one embodiment, a UI may be provided to allow end-users to select which assets they choose to follow, which creates the concept of “following”, whereby a user can be thought of as tracking or “following” the status of an IT asset(s). In one such implementation, certain role users (namely software group owners) may desire to follow not only certain assets but also groups of assets. Then, as there are changes made to that group, the software group owner would receive updates about such changes. In other implementations, an end user may wish to follow the assets which they are personally assigned to or that they are authorized to use. These end-users would receive alerts and notifications for the assets (possibly after they have elected to follow them, or automatically based on there connection to the assets). Examples includes being alerted when unauthorized software is found on a system, the asset changes location, when the asset is assigned to a new department, when the asset has been identified as being part of a lease that is up for renewal, etc.

In a further embodiment, updates for the assets may be displayed in a simplified page or UI which stores all the history for the communication of a given asset. This UI could also allow for the end-user to add ad-hoc comments about the asset. In one such example, prior to an office move an end-user could go to the assets that are planed to be moved and provide an ad-hoc message that the asset will be disconnected from the network for 3 days to allow for the move. Other users of the system that follow the assets, for example, a financial department manager for which those assets are assigned, would receive this ad-hoc notification and know that the assets will be off the network for a short period and possibly more importantly the reason for such absence from the network.

In the context of ERP, the UI page, blog, etc. that displays the messages, could be considered as a replacement for a traditional status history report. Further aspects of the present invention provides for a way to supplement or replace traditional reporting, in that information is automatically fed in real time which may eliminates the need to run or execute batch processes to create a report. When a user desires to see all history they can navigate to the consolidated UI. This may be part of the paradigm which shifts away from the classic reporting, whereby instant messaging and consolidated historical views (i.e., micro blog history) can be used as a report. Therefore, there is no need to run or execute batch processes to create a report, and thus micro blogging replaces classic way that reporting is created and consumed. The consolidated UI used as a report could be, for example, a link from the users portal (i.e., a link from MyYahoo™ to the Blog UI).

Furthermore, IT assets have a lifecycle and during its usage goes through different stages and statuses. In one embodiment of the present invention, these status changes are captured by micro blogging. For example, notifications to followers could be sent when the asset is assigned an asset tag, put into physical service, capitalized, reconciled, depreciated, etc. Further, in the context of traditional social networking micro blogging, the asset (IT, Financial or otherwise) object can take the place of the traditional micro blogging user of which other users would chose to follow. In one embodiment, users would follow IT assets or groups of IT assets instead of or in conjunction with following other users or user groups. For example, “status” can be considered as the messages being distributed to followers.

In a further embodiment, multiple sources for assets updates could be the location of the asset, such as from which IP Address it is connected, what discovery domain it comes from, updates from the custodian or administrator (via email, SMS or from application itself on desktop, portable devices), etc.

Aspects of the present invention provides a mechanism for simplified access to critical asset information, and will close the gap between the existing user behavior of using applications for personal use and business applications increasing the efficiency and productivity. Extensibility of the solution can significantly add value in existing ERP systems, in which the functionality of instant messaging was implemented to allow collaboration with the suppliers regarding invoice disputes. This may be particularly useful for accounts payable systems where there is no invoice dispute functionality, and as such, micro-blogs can be used to fill the gap not addressed by the ERP (Accounts Payable system). Therefore, if the invoice in dispute is chosen to be “followed” by the end user, then such existing capabilities could leverage the advantages offered from the micro-blogging functionality, such as seeing real time status updates or comments.

In another example, order management (OM), billing (BI), and account receivables (AR) systems creates transactions, such as orders, reservations, collections, etc., based on the customer information. This information may become available depending on the transaction's status which can be updated in the OM, the BI, and/or the AR. If the end user decides to follow a customer, the present invention could provide simplicity of bringing awareness of specific situations each time the followed customer information becomes updated either in the OM, the BI, and/or the AR. The simplified information would avoid the need of going through different enterprise modules, and therefore, would represent a significant saving in navigating several pages to verify the status. Following the same logic, the present invention can be an alternative more efficient solution for different functionalities already included in the current ERP system. Accordingly, micro-blogging can provide additional functionality that does not exist in the users' ERP applications by leveraging micro-blogging to fill in gaps in the ERP applications.

Furthermore, the present invention can be utilized more generally by any organization that needs to have a simplified mode to view financial information for the purpose of tracking it in real time. For example, the present invention can be applied in supply chain management (SCM) applications and implement for customers, vendors, or human capital management (HCM) systems to apply the same concept to, for example, employee ID, providers, etc.

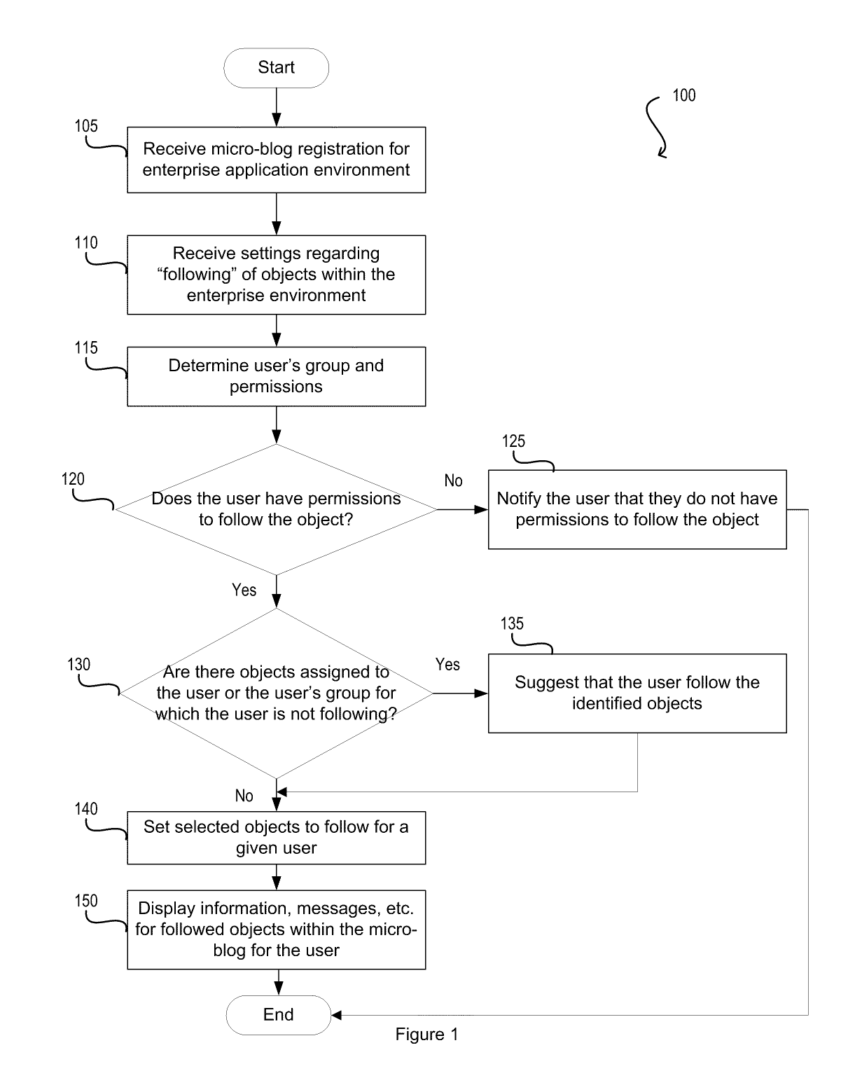

Turning now to FIG. 1, which illustrates a method 100 for implementing enterprise-based micro-blogging, in accordance with aspects of the present invention. At process block 105, a micro-blog registration for an enterprise application environment may be received. The registration may include an adjustment of account settings, account options, etc. The registration process may enable the user to send and receive micro-blog information within an enterprise application. In one embodiment, the enterprise application may be an ERP system, an HCM system, an SCM system, a customer information management system (i.e., OM, BI, or AR), etc. It should be noted that aspects of the present invention may be included in any number of enterprise applications and environments.

At process block 110, once the user has registered for micro-blogging, additional settings may be adjusted. For example, the user may select object or groups to “follow” within the enterprise application. In one embodiment, objects may be IT assets, clients, financial transaction, purchase orders, employees (and other human resource related objects), etc. Furthermore, “following” an object indicates that the users desired to receive micro-blog updates and information about the followed object. As such, if an IT manager is managing a laptop, then the manager would follow the laptop through the enterprise micro-blogging application, and thus receive updates and information about the laptop. The information and updated may include software that has been installed on the laptop, check-in and check-out data, failure information, etc. Accordingly, the manager following the laptop would receive real-time updates about the followed laptop.

An additional consideration regarding following objects may be the user's permissions and access level. For example, a low-level user may not be allowed to follow certain objects, such as an employee being able to follow a manager's human resource information. Alternatively, if an individual is not an IT manager, they may only be able to follow hardware and software specifically assigned to them, whereas the IT manager may have access to all hardware devices. Furthermore, a user may be restricted based on the group (i.e., IT administrators, human resources, finance, etc.) they belong to. Thus, at process block 115, a determination is made regarding the user's group and permissions.

At decision block 120, based on the permissions of the user, a determination is made whether the user is able to “follow” the selected object. If the user is unable to follow the selected object, then at process block 125, the user is notified (through the enterprise application) that they are unable to follow the selected object due to lack of proper permissions.

Alternatively, if it is determined that the user has proper permissions, then at decision block 130, a determination may be made whether the there are objects within the user's group of direct control (or management), that the user is not following. For example, the user may be an IT manager, and is thus responsible for thousands of hardware devices; however, the user may only be following five hundred of the devices. Accordingly, if it is determined that the user is not assigned to objects, then at process block 135, the user may receive suggested object which he/she should follow.

Further, the user is then set to follow any of the authorized and selected objects (process block 140). Thus, the user is now able to receive information displayed, for example, within a UI, about the objects which the user is following within the micro-blog application. Accordingly, the user received real-time updates and information for each of the followed objects, as well as the ability to submit their own updates and comments about the followed objects.

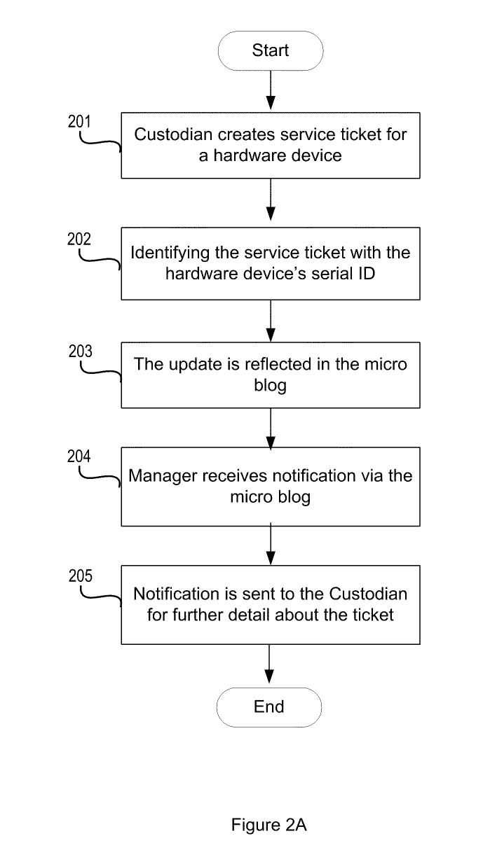

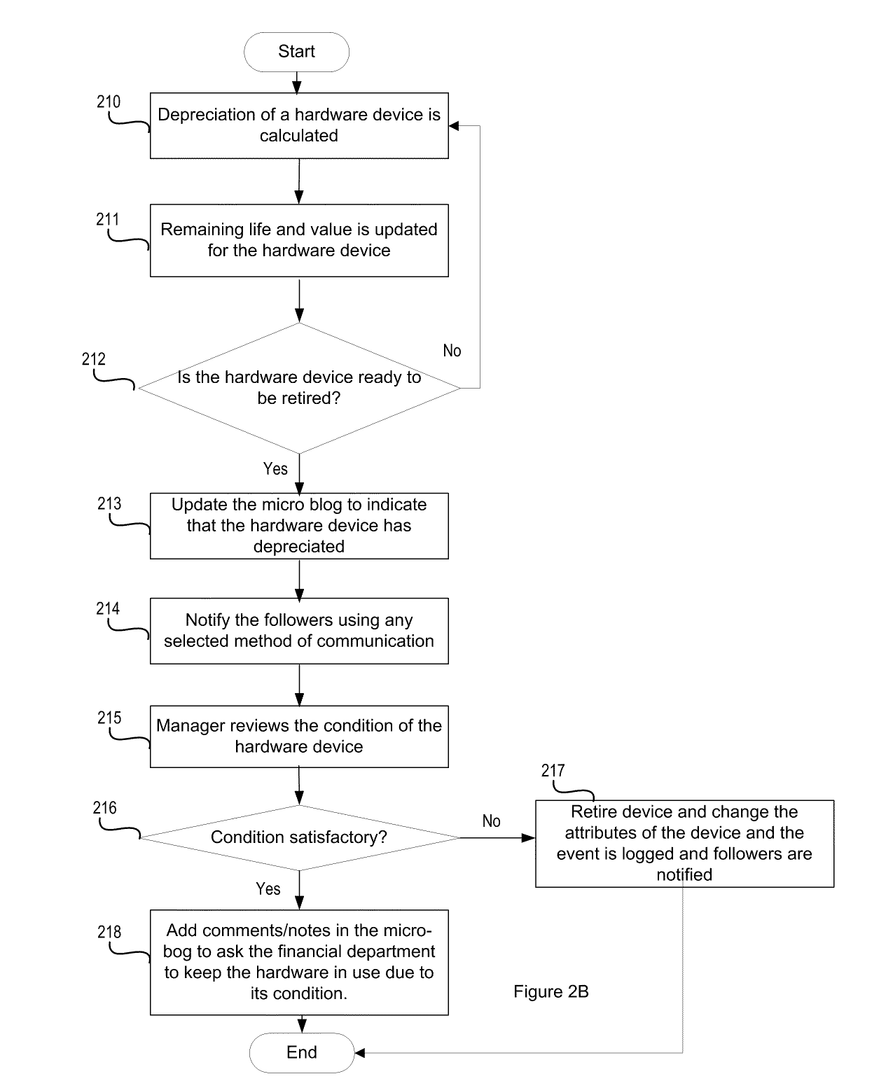

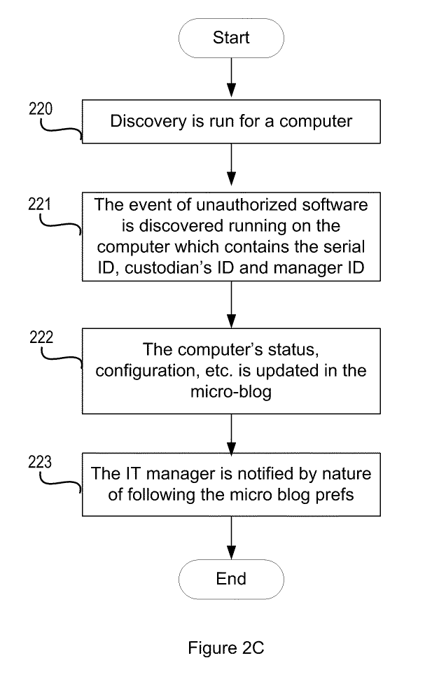

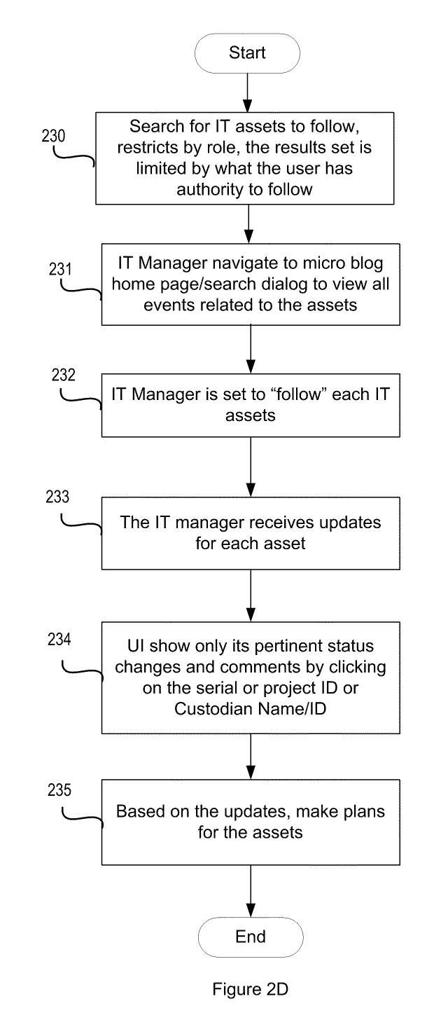

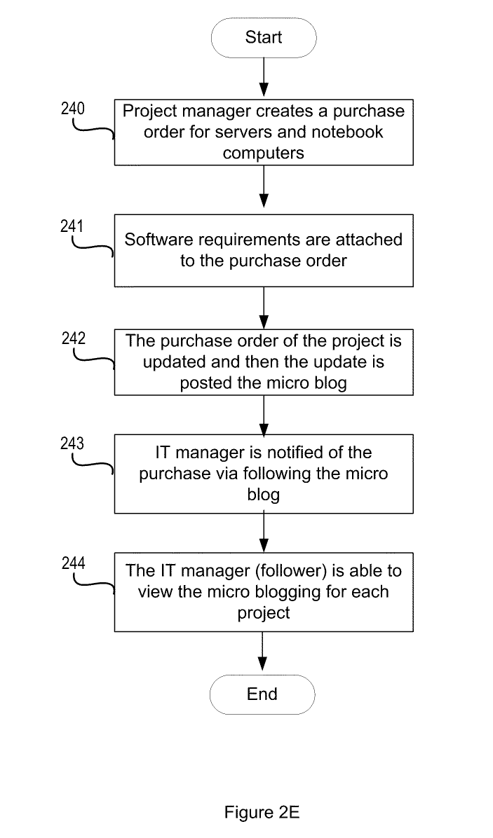

Referring next to FIG. 2A, which illustrates a method for implementing micro-blogging for custodian hardware management, in accordance with embodiments of the present invention. At process block 201, for example, a custodian of an object may create a service ticket for a hardware device (e.g., the user's monitor is malfunctioning). Thus, at process block 202, identify the service ticket with the hardware device's serial ID.

In response, the update is reflected within the micro-blog for the monitor (process block 203). The entry in the micro-blog may include the hardware ID and an attached message that the device has failed, along with possibly the custodian's name, contact number, and employee ID. Then, at process block 204, the IT manager (of the monitor), which is following the monitor because he/she is the manager for the monitor, receive notification of the ticket and the nature of the failure within the micro-blog. In one embodiment, any event that is posted to the micro-blog, can be automatic, and can also physically go into the asset to provide comments so that followers are notified of all types of events.

Accordingly, the manager may repair, replace, etc. the monitory, which would be included in the micro-blog. The custodian would then receive such notification within the micro-blog regarding the status of the monitor. Thus, this describes one example of haw the enterprise-based micro-blogging may be utilized and implemented.

Turning next to FIG. 2B, which illustrates a method for managing hardware (and other asset) depreciation using micro-blogging, in accordance with embodiments of the present invention. At process block 210, the depreciation of a hardware device may be calculated, and the remaining life and value of the hardware device is updated within the micro-blog (process block 211). In one embodiment, the calculation of depreciation, remaining life, replacement costs, etc. may be done in the ERP system and reflected in the micro-blog. Furthermore, the micro-blogging system may perform the calculation. Alternatively, an existing ERP's module may complete the corresponding calculation, and the enterprise based micro-blogging system would be updated based the change of status.

At decision block 212, a determination is made whether the hardware device should be retired. If it is determined that the hardware device should not be retired then depreciation determination process continues. If it is determined that the device should be retired, then at process block 213, the micro-blog is updated to reflect that the hardware device has been depreciated. Then, at process block 214, the IT manager for the device is notified via the micro-blog (again, the manger is following the device).

In one embodiment, the manager review the condition of the device (process block 215), the manage then makes a determination as to whether the condition is still satisfactory (decision block 216). If it is determine that the device is not satisfactory (or has depreciated sufficiently), the manager may determine that the device should be retired, as such, at process block 217, the manager may notify, for example, the financial department about the retired device via the micro-blog.

Alternatively, if the device is determined to still be in satisfactory condition, then the manager may add a comment/note in the micro-blog to request that the financial department keep the hardware in use do to the condition. In addition, the custodian may also be made aware that the device is still in use, retired, etc.

Referring next to FIG. 2C, which illustrates a method for managing software installation and usage using micro-blogging, in accordance with embodiments of the present invention. At process block 220, discovery may be run on a computer. For example, a sweep of a computer's software may be done to check for unauthorized or unlicensed software. At process block 221, any unauthorized software is discovered running on the computer.

At process block 222, the computer's status, configuration, etc. is updated in the micro-blog. As such, the IT manager (or authorized follower) may then be notified of the offending software and computer via the micro-blog, and any necessary actions can then be taken (process block 223).

Referring now to FIG. 2D, which illustrates a method for implementing micro-blogging for IT managers, in accordance with embodiments of the present invention. At process block 230, IT assets may be searched to determine which assets to “follow”. In one embodiment, the result set may be restricted by role, and only the assets for which the user has authority to follow are displayed. At process block 231, an IT manager is able to navigate to a micro-blog home page, or similar UI. The IT manager is set to follow each IT asset (process block 232). At process block 233, the IT manager then receives updates and information about each asset via the micro-blog. In one embodiment, the UI may show pertinent status changes and comments by clicking on the serial ID or project ID, or even the custodian name/ID (process block 234). As such, based on the updates the IT manager is able to make plans for each of the IT assets that they manage (process block 325).

FIG. 2E illustrates a method for purchase order management using micro-blogging, in accordance with embodiments of the present invention. At process block 240, a purchase order may be created by a project manager for an order of, for example, servers and notebooks. In one embodiment, the purchase order information may be posted on the micro-blog, and as such anyone following the purchase order may then be notified of the updates to the purchase order.

At process block 241, software requirements may also be attached to the purchase order, and such information may also be distributed via the micro-blog. Accordingly, the purchase order, project name, etc. are updated on the micro-blog and all of the followers receive the updated information (process block 242). At process block 243, the IT manager (or follower) may be notified of the purchase, also via the micro-blog. Then, at process block 244, the IT manager (or follower) is able to view and comment on the project and purchase order via the micro-blog.

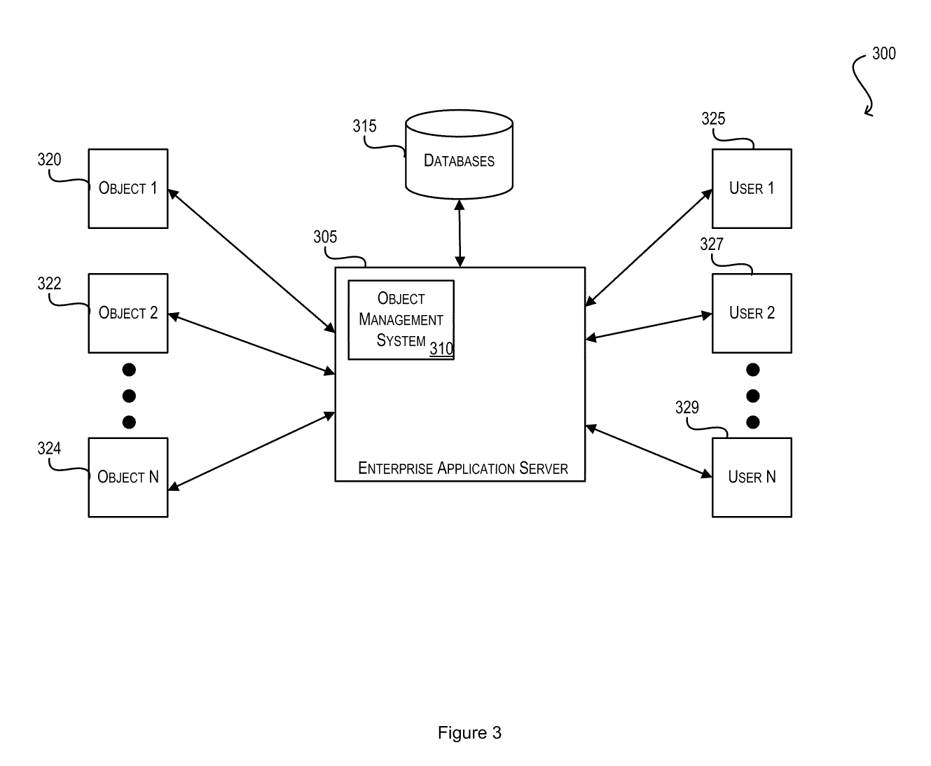

Turning now to FIG. 3, which illustrates a system 300 for implementing enterprise-based micro-blogging, in accordance with aspects of the present invention. In one embodiment, system 300 includes an enterprise application server 305, which also includes an object management system 310. The enterprise application server may run any number of enterprise applications, for example, an ERP system, an HCM system, an SCM system, a customer information management system (i.e., OM, BI, or AR), etc.

In one embodiment, the object management system 310 may be configured to manage information, updates, comments, etc. about objects within the enterprise application. The object management system 310 may also be configured to implement a micro-blog for objects associated with the enterprise application (i.e., object 1 320, object 2 322, and object N 324). Furthermore, users 1325, 1327, and N 329 may be followers of any one of objects 320, 322, or 324. As such, as comments, updates, changes, etc. occur with regard to any one of the objects, the object management system 310 may then process the information and post it to the following users of the corresponding object. Accordingly, the users 325, 327, and 329 are able to receive real-time updates of about the objects. Furthermore, system 300 may be used to implement any one of the methods described in FIG. 1 or 2A-2E.

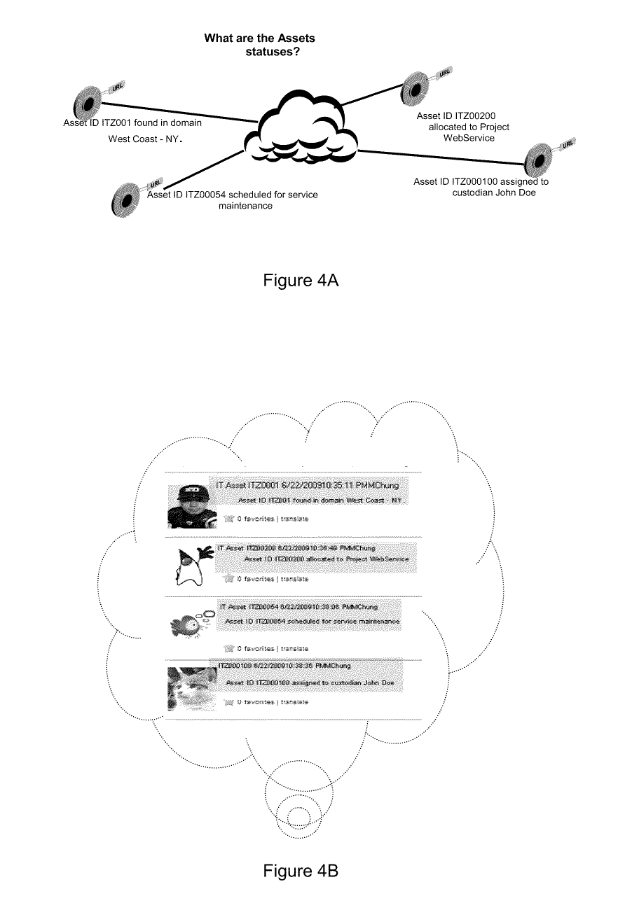

Using the graphical interface of FIGS. 4A and 4B, end users may register to the micro blog feature. The end users may also set “follow” to an asset, project, employee, employee group, etc. Then, the selected assets, projects, employees, employee group, set to follow are changed to “following” for the user. These objects will then be displayed in each registered user's page(s). The registered user will now be displayed activities related to the objects that are set to follow. In one embodiment, FIG. 4 displays to the user “tweets” from non-humans (i.e., system generated notifications). As such, this provides a history of all of the objects that a user is following.

A number of possible status messages may be displayed within the UI. For example, Table 1 describes various possible status messages:

TABLE 1

Added to Asset Management System
Replaced
Replacement part ordered
Service ticket created for the asset
Scheduled for maintenance service
Retired
Depreciated
Retired Not In Use
Retired In Use
In Physical Use/Not In Physical Use
Custodian Change
Manger of the custodian change
Transferred to different Business Unit (BU)
Transferred to different Inventory Warehouse
Custodian/User of Hardware (HW) has added
review/comments.
New IP address
Track IP Address from which the HW has connected
Authorized Software Title is installed in HW MAC Address
Unauthorized Installation of Software (SW) in HW MAC
Address
Unauthorized user of HW
Custodian differ from authorized user
Maintenance Date is in xx days.
HW with unauthorized SW discovered and not in Asset
Management System
HW in Asset Management System but not in Discovery
HW has PO requisition ID associated and added to Asset
Management System
HW has PO requisition ID associated for purchase accessory
HW's PO Requisition Approval/Not Approved
Financial Asset became Non Financial Asset
Non Financial Asset is Not in Use
Asset appeared in Asset Not Reporting list
Asset is listed in Manage Exception List
Asset has ignored action applied from Manage Exception
To be defined more based on the implementation of ERP,
HCM, CRM, SCM.

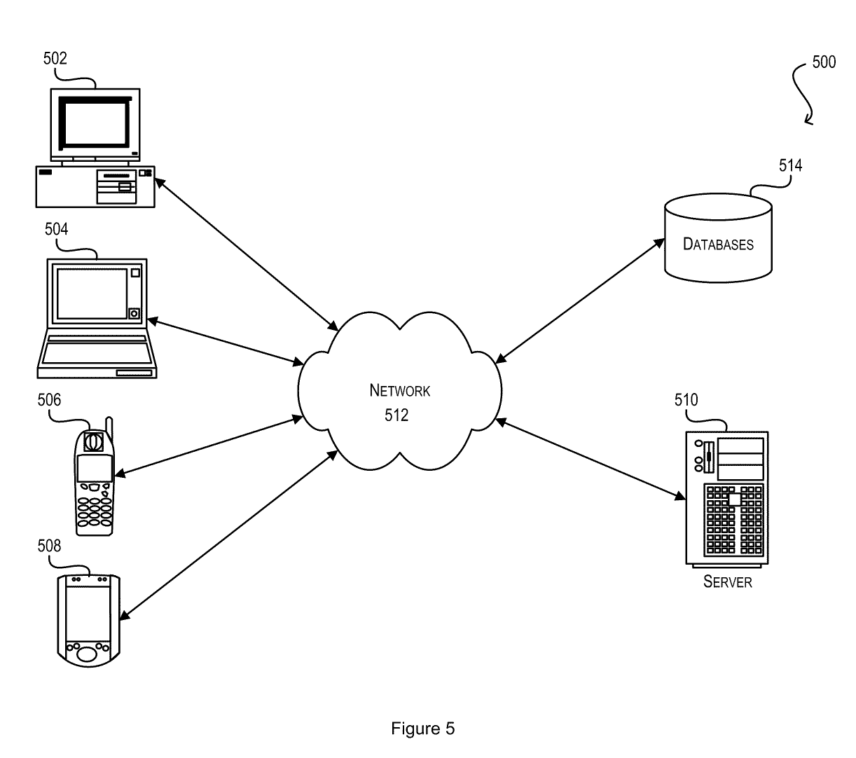

FIG. 5 is a simplified block diagram illustrating physical components of a system environment 500 that may be used in accordance with an embodiment of the present invention. This diagram is merely an example, which should not unduly limit the scope of the claims. One of ordinary skill in the art would recognize many variations, alternatives, and modifications; including, but not limited to, the data and message originated/received from one or many sources associated with IP Address or other identifier for a device.

As shown, system environment 500 includes one or more client computing devices 502, 504, 506, 508 communicatively coupled with a server computer 510 via a network 512. In one set of embodiments, client computing devices 502, 504, 506, 508 may be configured to run one or more components of a graphical user interface described above. For example, client computing devices allow user to create and customize network communities, enter search queries, view search results, and others.

Client computing devices 502, 504, 506, 508 may be general purpose personal computers (including, for example, personal computers and/or laptop computers running various versions of Microsoft Windows™ and/or Apple Macintosh™ operating systems), cell phones or PDAs (running software such as Microsoft Windows™ Mobile and being Internet, e-mail, SMS, Blackberry™ and/or other communication protocol enabled), and/or workstation computers running any of a variety of commercially-available UNIX™ or UNIX™-like operating systems (including without limitation the variety of GNU/Linux™ operating systems). Alternatively, client computing devices 502, 504, 506, and 508 may be any other electronic device capable of communicating over a network (e.g., network 512 described below) with server computer 510. Although system environment 500 is shown with four client computing devices and one server computer, any number of client computing devices and server computers may be supported.

Server computer 510 may be a general purpose computer, specialized server computer (including, e.g., a LINUX™ server, UNIX™ server, mid-range server, mainframe computer, rack-mounted server, etc.), server farm, server cluster, or any other appropriate arrangement and/or combination. Server computer 510 may run an operating system including any of those discussed above, as well as any commercially available server operating system. Server computer 510 may also run any of a variety of server applications and/or mid-tier applications, including web servers, Java virtual machines, application servers, database servers, and the like. In various embodiments, server computer 510 is adapted to run one or more Web services or software applications described in the foregoing disclosure. For example, server computer 510 is specifically configured to implemented enterprise procurement systems described above.

As shown, client computing devices 502, 504, 506, 508 and server computer 510 are communicatively coupled via network 512. Network 512 may be any type of network that can support data communications using any of a variety of commercially-available protocols, including without limitation TCP/IP, SNA, IPX, AppleTalk™, and the like. Merely by way of example, network 512 may be a local area network (LAN), such as an Ethernet network, a Token-Ring network and/or the like; a wide-area network; a virtual network, including without limitation a virtual private network (VPN); the Internet; an intranet; an extranet; a public switched telephone network (PSTN); an infra-red network; a wireless network (e.g. any network standard established by IEEE, including WiMax); and/or any combination of these and/or other networks. In various embodiments, the client computing devices 502, 504, 506, 508 and server computer 510 are able to access the database 514 through the network 512. In certain embodiments, the client computing devices 502, 504, 506, 508 and server computer 510 each has its own database.

System environment 500 may also include one or more databases 514. Database 514 may correspond to an instance of integration repository as well as any other type of database or data storage component described in this disclosure. Database 514 may reside in a variety of locations. By way of example, database 514 may reside on a storage medium local to (and/or resident in) one or more of the computing devices 502, 504, 506, 508, or server computer 510. Alternatively, database 514 may be remote from any or all of the computing devices 502, 504, 506, 508, or server computer 510 and/or in communication (e.g., via network 512) with one or more of these. In one set of embodiments, database 514 may reside in a storage-area network (SAN) familiar to those skilled in the art. Similarly, any necessary files for performing the functions attributed to the computing devices 502, 504, 506, 508, or server computer 510 may be stored locally on the respective computer and/or remotely on database 514, as appropriate. For example the database 514 stores user profiles, procurement information, attributes associated with network entities.

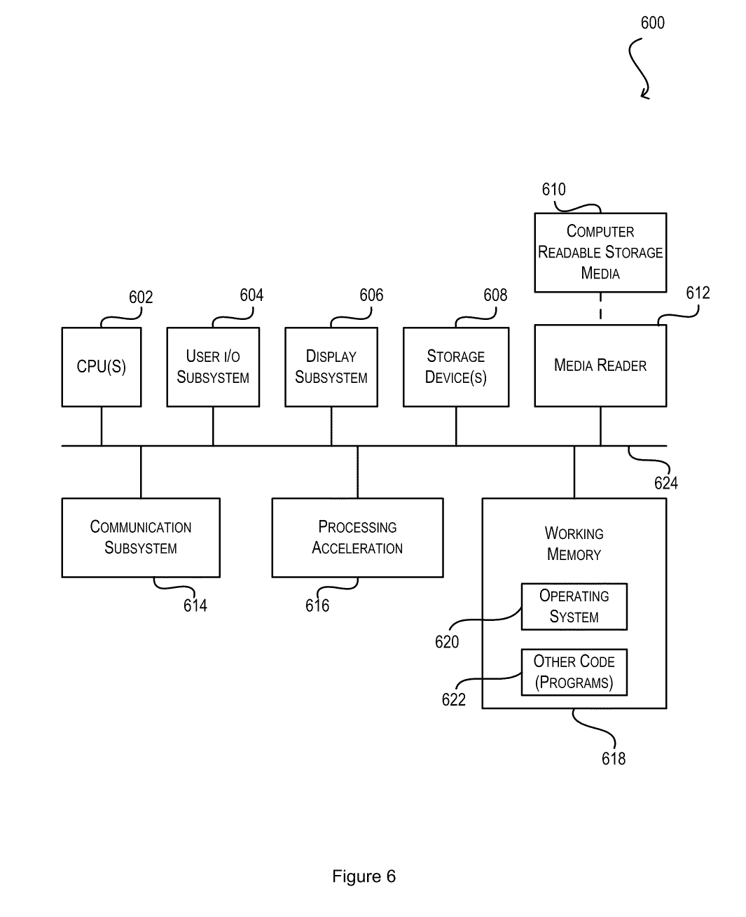

FIG. 6 is a simplified block diagram illustrating the physical components of a computer system 600 that may be used in accordance with an embodiment of the present invention. This diagram is merely an example, which should not unduly limit the scope of the claims. One of ordinary skill in the art would recognize many variations, alternatives, and modifications.

In various embodiments, computer system 600 may be used to implement any of the computing devices 602, 604, 606, 608, or server computer 610 illustrated in system environment 600 described above. As shown in FIG. 6, computer system 600 comprises hardware elements that may be electrically coupled via a bus 624. The hardware elements may include one or more central processing units (CPUs) 602, one or more input devices 604 (e.g., a mouse, a keyboard, etc.), and one or more output devices 606 (e.g., a display device, a printer, etc.). For example, the input devices 604 are used to receive user inputs for procurement related search queries. Computer system 600 may also include one or more storage devices 608. By way of example, storage devices 608 may include devices such as disk drives, optical storage devices, and solid-state storage devices such as a random access memory (RAM) and/or a read-only memory (ROM), which can be programmable, flash-updateable and/or the like. In an embodiment, various databases are stored in the storage devices 608. For example, the central processing units 602 is configured to retrieve data from a database and process the data for displaying on a GUI.

Computer system 600 may additionally include a computer-readable storage media reader 612, a communications subsystem 614 (e.g., a modem, a network card (wireless or wired), an infra-red communication device, etc.), and working memory 618, which may include RAM and ROM devices as described above. In some embodiments, computer system 600 may also include a processing acceleration unit 616, which can include a digital signal processor (DSP), a special-purpose processor, and/or the like.

Computer-readable storage media reader 612 can further be connected to a computer-readable storage medium 610, together (and, optionally, in combination with storage devices 608) comprehensively representing remote, local, fixed, and/or removable storage devices plus storage media for temporarily and/or more permanently containing computer-readable information. Communications system 614 may permit data to be exchanged with network 612 of FIG. 6 and/or any other computer described above with respect to system environment 600.

Computer system 600 may also comprise software elements, shown as being currently located within working memory 618, including an operating system 620 and/or other code 622, such as an application program (which may be a client application, Web browser, mid-tier application, RDBMS, etc.). In a particular embodiment, working memory 618 may include executable code and associated data structures. It should be appreciated that alternative embodiments of computer system 600 may have numerous variations from that described above. For example, customized hardware might also be used and/or particular elements might be implemented in hardware, software (including portable software, such as applets), or both. Further, connection to other computing devices such as network input/output devices may be employed. In various embodiments, the behavior of the view functions described throughout the present application is implemented as software elements of the computer system 600.

In one set of embodiments, the techniques described herein may be implemented as program code executable by a computer system (such as a computer system 600) and may be stored on machine-readable media. Machine-readable media may include any appropriate media known or used in the art, including storage media and communication media, such as (but not limited to) volatile and non-volatile, removable and non-removable media implemented in any method or technology for storage and/or transmission of information such as machine-readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, or any other medium which can be used to store or transmit the desired information and which can be accessed by a computer.

Although specific embodiments of the present invention have been described, various modifications, alterations, alternative constructions, and equivalents are within the scope of the invention. Further, while embodiments of the present invention have been described using a particular combination of hardware and software, it should be recognized that other combinations of hardware and software are also within the scope of the present invention. The present invention may be implemented only in hardware, or only in software, or using combinations thereof.

The specification and drawings are, accordingly, to be regarded in an illustrative rather than a restrictive sense. Many variations of the invention will become apparent to those skilled in the art upon review of the disclosure. The scope of the invention should, therefore, be determined not with reference to the above description, but instead should be determined with reference to the pending claims along with their full scope or equivalents.

What is claimed is:

1. A method for implementing enterprise application-based micro-blogging, the method comprising:
receiving a micro-blog registration for an enterprise application for at least one user;
verifying the role and access level of the user;
based on the registration, the role, and access level, receiving setting information from the at least one user to configure following of at least one object associated with the enterprise application;
recording an event to the micro-blog for the at least one object;
determining that the at least one user is configured to follow the at least one object;
in response to following the at least one object, receiving a notification that at least one update to the at least one object has occurred; and
displaying, in real-time, within the enterprise application-based micro-blog the at least one update to the at least one object to the at least one user.

2. A method for implementing enterprise application-based micro-blogging, as in claim 1, wherein the displaying occurs in a home, assets, or individual user's micro-blogging page.

3. A method for implementing enterprise application-based micro-blogging, as in claim 2, wherein each object has a home page and each user has a home page.

4. A method for implementing enterprise application-based micro-blogging, as in claim 3, wherein the user's home page includes links to each or the home pages of each of the object which the user is following.

5. A method for implementing enterprise application-based micro-blogging, as in claim 1, wherein the at least one event changes due to automatic changes made by an object management system.

6. A method for implementing enterprise application-based micro-blogging, as in claim 1, further comprising receiving an event for the at least one object from a user which is following the at least one object.

7. A method for implementing enterprise application-based micro-blogging, as in claim 1, further comprising creating an ad-hoc notification or comment for the at least one object from a user which is following the at least one object.

8. A method for implementing enterprise application-based micro-blogging, as in claim 1, wherein the at least one object comprises one or more of the following: an IT asset, a purchase order, or a vendor.

9. A method for implementing enterprise application-based micro-blogging, as in claim 1, wherein the notification includes an actionable item.

10. A method for implementing enterprise application-based micro-blogging, as in claim 9, wherein the link to the actionable item brings the user to a home page of the object associated with the actionable item.

11. A method for implementing enterprise application-based micro-blogging, as in claim 1, wherein following an object comprises receiving notifications about the object.

12. A method for implementing enterprise application-based micro-blogging, as in claim 1, further comprising in response to not verifying the role and access level of the use, notifying the user that their permissions are insufficient to follow the at least one object.

13. A method for implementing enterprise application-based micro-blogging, as in claim 1, further comprising providing suggested objects for the at least one user to follow.

14. A method for implementing enterprise application-based micro-blogging, as in claim 1, further comprising identifying the at least one user's associated group(s).

15. A method for implementing enterprise application-based micro-blogging, as in claim 14, further comprising based on the at least one user's identified group, determining objects associated with the group.

16. A method for implementing enterprise application-based micro-blogging, as in claim 15, further comprising identifying objects in the group for which the at least one user is not following.

17. A method for implementing enterprise application-based micro-blogging, as in claim 16, further comprising recommending that the at least one user follow the identified objects.

18. A non-transitory computer-readable medium for implementing enterprise application-based micro-blogging, having sets of instructions stored thereon which, when executed by a computer, cause the computer to:
receive a micro-blog registration for an enterprise application for at least one user;
verify the role and access level of the user;
based on the registration, the role, and access level, receive setting information from the at least one user to configure following of at least one object associated with the enterprise application;
record an event to the micro-blog for the at least one object;
determine that the at least one user is configured to follow the at least one object;
in response to following the at least one object, receive a notification that at least one update to the at least one object has occurred; and
display, in real-time, within the enterprise application-based micro-blog the at least one update to the at least one object to the at least one user.

19. The non-transitory computer-readable medium of claim 18, wherein each object has a home page and each user has a home page.

20. A system for implementing enterprise application-based micro-blogging, the system comprising:
an object management system configured to:
receive a micro-blog registration for an enterprise application for at least one user;
verify the role and access level of the user;
based on the registration, the role, and access level, receive setting information from the at least one user to configure following of at least one object associated with the enterprise application;
record an event to the micro-blog for the at least one object;
determine that the at least one user is configured to follow the at least one object;
in response to following the at least one object, receive a notification that at least one update to the at least one object has occurred; and
display, in real-time, within the enterprise application-based micro-blog the at least one update to the at least one object to the at least one user.
